(19) United States
(12) Patent Application Publication
(10) Pub. No.: US 2026/0369979 A1
(43) Pub. Date: Nov. 19, 2026

(54) Wire Stock Fixing Device

(71) Applicant: Fuzhou Mawei District Laisi Trading Co., Ltd., Fuzhou (CN)

(72) Inventor: Longyu Xun, Fuzhou (CN)

(21) Appl. No.: 19/663,059

(22) Filed: Apr. 29, 2026

(30) Foreign Application Priority Data
May 13, 2025 (CN) 202520935320X

(51) Int. Cl. H02G 3/32; H02G 3/04

(52) U.S. Cl. CPC H02G 3/32; H02G 3/0412

(57) ABSTRACT

A wire stock fixing device includes a connecting strap and a hook; the hook connects to the connecting strap; a side of the connecting strap is designed as a loop surface; another side of the connecting strap is designed as a hook surface; the wire stock fixing device forms a binding hole in different sizes, so as to wrap and bind wires in different specifications and sizes; thus, the wire stock fixing device has a wider application range; in addition, it has a firmer connection effect and a user does not worry that the wires loosened or detached accidentally; besides, it can be alternately adhered with two sides, which makes it a longer service life.

### CROSS-REFERENCE TO RELATED APPLICATIONS

The present application claims the benefit of Chinese Patent Application No. 202520935320X filed on May 13, 2025, the contents of which are hereby incorporated by reference.

### TECHNICAL FIELD

The present invention belongs to the technical field of fixing straps, and in particular relates to a wire stock fixing device.

### Technical Background

In a power distribution system, it is extremely important to fix and bind electric wires and cables firmly so as to secure stable power transmission safely. At present, workers usually adopt a traditional hook-and-loop fastener wire stock fixing device to fix and bind electric wires and cables, however, the traditional hook-and-loop fastener wire stock fixing device is only provided with a hook surface or a loop surface on a single face, as a result, the hook surface becomes bad adhesion after repeated uses, which results in a short service life, and failing to satisfy a long-term use requirement. Furthermore, a single-side adhesive surface design limits itself only by forming a binding hole in one size, in other words, it fails to fix and bind electric wires in different specification sizes, thus, it has a limiting application range.

### Invention Content

In order to overcome the shortcomings of the prior art, the present invention provides a wire stock fixing device, which can form a binding hole in different sizes so as to fix and bind electric wires in different specification sizes, and so the wire stock fixing device is used in extensive range; in addition, the wire stock fixing device has a better and firmer adhesion and fixing function, thus, a user does not worry that the electric wires loosened or detached accidentally; besides, it can be alternately adhered with two sides, which makes it a longer service life.

The technical solution adopted by the present invention for solving the technical problem is:

The wire stock fixing device comprises a connecting strap and a hook; the hook connects to the connecting strap; a side of the connecting strap is designed as a loop surface; another side of the connecting strap is designed as a hook surface; the hook surface and the loop surface cooperate with each other forming a detachable connection.

Further, the hook connects to a middle position of the connecting strap.

Further, the connecting strap is integrally formed; the middle position of the connecting strap is set as a bending part; an end of the connecting strap fold up with another end of the connecting strap at the bending part; the middle position of the connecting strap is sewed with a stitching line and forms a connecting hole; the hook is fixedly connected with the connecting strap via the connecting hole.

Further, the hook surface on the connecting strap is provided with a plurality of rows and columns of hook elements; each of the plurality of rows and columns of hook elements are arranged alternately in left and right directions.

Further, each of two ends of the connecting strap is provided with a hard shell.

Further, the hard shell is designed as an arc-shaped structure for all corner edges.

Further, a top end of the hook elements on the hook surface is designed as a rounded corner.

Further, the hook is provided with a spring switch.

Further, the hook is provided with an additional hole.

Further, the connecting strap is made of a flame-retardant nylon material.

The beneficial effects of the present invention are as follows:

The wire stock fixing device provided by the present invention is able to form a binding hole in different sizes, so as to fix and bind wires of different specification sizes, thus, it has wider usage scopes; besides, the wire stock fixing device applies a self-compression design to reach a firmer adhesion function, a user does not worry that the wires loosened or detached accidentally; finally, it is designed with two side adhesion function, which makes it a longer service life.

### DESCRIPTION OF FIGURES

FIG. 1 is a front view of a wire stock fixing device according to the present invention;

FIG. 2 is a schematic diagram of the wire stock fixing device;

FIG. 3 is a schematic diagram of the wire stock fixing device in an adhered state;

FIG. 4 is a schematic diagram showing one wire stock fixing device hooked on another wire stock fixing device via an additional hole;

Description of marks in figures:
1-connecting strap;
11-loop surface;
12-hook surface;
13-bending part;
14-stitching line;
15-connecting hole;
2-hook;
21-spring switch;
22-additional hole;
3-hard shell;
31-arc-shaped structure

### DETAILED DESCRIPTION OF THE EMBODIMENTS

The present embodiment only shows an explanation of the present invention, and it is not a limitation to the present invention. The skilled in the art can make modifications to this embodiment as needed without making any creative contributions after reading this specification, which are always protected by the patent law as long as they are within the scope of the claims of the present invention.

It should be noted that when an element is referred to be“fixed to” or “arranged on” another element, the element may be directly on the another element or indirectly on the another element; when an element is referred to be “connected to” another element, the element can directly connects to the other element or indirectly connects to the other element.

It should be understood that, a plurality of terms included “length”, “width”, “up”, “down”, “front”, “rear”, “left”, “right”, “vertical”, “horizontal”, “top”, “bottom”, “inner”, “outer” and so on; orientation or position relationships indicated by the terms are based on the drawings, which are only used to facilitate description of the present invention and simplify the description, rather than indicating or implying that the device or element referred to must have a specific orientation, and be constructed and operated in a specific orientation; therefore that cannot be construed as a limitation on the present invention.

In addition, terms such as “first” and “second” are used herein for purposes of description and are not intended to indicate or imply relative importance or significance or to imply the number of indicated technical features. Thus, the features defined by “first” and “second” may explicitly or implicitly include one or more of the features. In the description of some inventions, the meaning of “a plurality of” is two or more, unless specified otherwise.

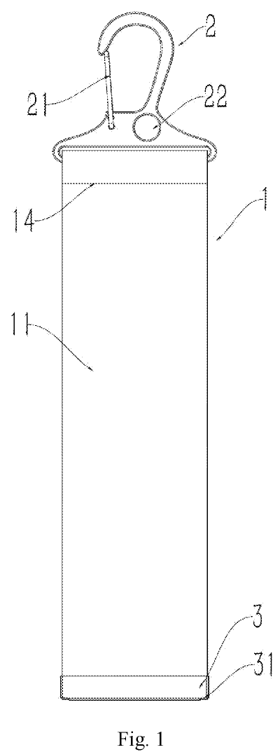

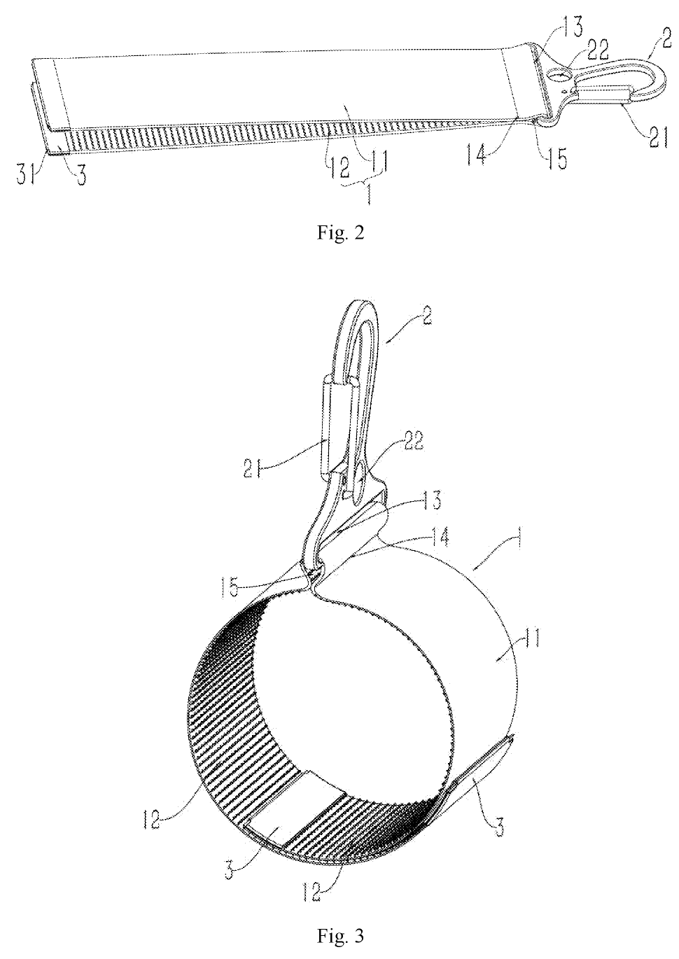

Referring to FIGS. 1-3, the present embodiment provides a wire stock fixing device, comprising a connecting strap 1 and a hook 2; the hook 2 connects to the connecting strap 1; one side of the connecting strap 1 is designed as a loop surface 11; another side of the connecting strap 1 is designed as a hook surface 12; the hook surface 12 and the loop surface 11 cooperate with each other forming a detachable connection.

It can be understood that, bending the wire stock fixing device itself, the loop surface 11 and the hook surface 12 connect together, so as to fix and bind electric wires and then fix on an insulator, a crossarm or a poles-and-towers via the hook 2, in this way, it prevents the electric wires from shaking or detaching; the wire stock fixing device satisfies various requirements such as fixing and bundling the electric wires or cables.

Preferably, the hook 2 connects to a middle position of the connecting strap 1; the hook 2 divides the connecting strap 1 into two parts; the user just needs to bend the two parts of the connecting strap 1 to let the two parts adhere to each other.

Since the two sides of connection strap 1 are respectively provided with the hook surface 12 and the loop surface 11; the two parts of the connection strap 1 can bend at different angles and then adhere together, so as to form a binding hole in different sizes, in this way, the user can use the wire stock fixing device to fix and bind the electric wires and cable in different specification sizes; thus, the wire stock fixing device has a wider application range.

For ease of description, two parts of the connecting strap 1 divided by the hook 2 are respectively set as a first connecting strap and a second connecting strap; the user can adhere an outer surface of the first connecting strap to an inner surface of the second connecting strap; also, the user can adhere an outer surface of the second connecting strap to an inner surface of the first connection strap, thereby achieving an alternative adhesion function to prolong a service life of the wire stock fixing device.

Assuming only one surface of the wire stock fixing device is adhesive, the hook surface 12 easily becomes bad adhesion after repeated use; it affects a fastening performance, however, the wire stock fixing device provided by this embodiment is provided with the hook surface 12 and the loop surface 11 on two sides, thus, the wire stock fixing device has a double service life of the wire stock fixing device with a single-side adhesion function.

In the present embodiment, the connecting strap 1 is integrally formed; the middle position of the connecting strap 1 is set as a bending part 13; when fold up the two parts of the connecting strap 1, the bending part 13 at the middle position is curved; a stitching line 14 is sewed at two ends of the bending part; the bending part 13 forms a connecting hole 15; as shown in FIG. 3, it could be understand that the bending part 13 encloses the connecting hole 15; the bending part 13 is the middle position of the connecting strap 1; the hook 2 is fixedly connected with the connecting strap 1 via the connecting hole 15.

During processing, first thread the connecting strap 1 through the hook 2, and fold up the connecting strap 1, then sew the two parts of the connecting strap 1 at the middle position to fix the hook 2 with the connecting hole 15, once the processing is completed, the hook 2 is fixedly connected with the connecting strap 1, and a position of the hook 2 on the connecting strap 1 cannot be changed.

Preferably, the hook surface 12 of the connection strap 1 is provided with a plurality of rows and columns of hook elements; each of the plurality of rows and columns of hook elements are arranged alternately in left and right directions.

It can be understood that the alternate arrangement in left and right directions improves contact areas and hooking points between the two parts of the connecting strap 1, so as to reach a more stable connection effect. At the same time, such alternate arrangement also helps to distribute a force and tensile resistance from an external object or items; for example, when the hook surface and the loop surface under a tensile force, the alternate arrangement design for hooks helps to distribute the tensile force in different directions; in detail, left side hooks take the tensile force rightward, while right side hooks bear the tensile force leftward, forming a “mutually pulling” mechanical structure, in this way, to reach a firmer adhesion effect. When the connecting strap 1 is under a vertical tensile force, the user no longer worries that it will loosen or fall off, which reduces the risk of accidental falling-off.

Referring to FIG. 3, during use, the two parts of the connecting strap 1 bend towards each other and adhere to each other; the two parts of the connecting strap 1 are connected and adhered with each other just directly below wire stocks that are bound, a gravity of the wire stocks generate a continuous downward pressure on a connection coupling position of the connecting strap 1, which makes the hook face and the loop face adhere with each other more tightly; in other words, the two parts of the connecting strap 1 are connected with each other firmly, thereby preventing looseness or detachment. In addition, such a self-compression design based on gravity does not require an additional locking structure, thus, it is easy to use and has high reliability. Even if those wire stocks are vibrated or pulled by an external force, a downward pressure from the gravity of the wire stocks can still maintain a firm adhesion and connection between the two parts of the connecting straps 1, in this way, it helps to avoid any accidental disengagements caused by the external forces. Compared with a traditional cable tie or a single-side hook-and-loop fastener, the wire stock fixing device applies the gravity the wire stocks to achieve a self-locking effect, in specific, the heavier of the wire stocks, the firmer adhesion of the two parts of the connecting strap 1; as a result, the wire stock fixing device is suitable to use in power transmission system scenario, for it requires a long-term stable binding of the electric wires and cables to secure safety.

Preferably, each of two ends of the connection strap 1 is provided with a hard shell 3.

In this embodiment, the hard shell 3 is made of a metal material; the hard shell 3 is tightly clamped on each of the two ends of the connection strap 1 via a pressing process; the user can easily tear off the two parts of the connecting strap 1 with a help of the hard shell 3, and improves an operation efficiency; the hard shell 3 plays a role as a force supporting point, when the user pulls the hard shell 3, a pulling force will convert into a lever force so as to avoid directly pulling off soft fibers of the loop surface; moreover, the user can separate the two parts of the connecting strap 1 only with one hand as well with the help of the hard shell 3. In addition, the hard shell 3 also protect an edge of the two ends of the connecting strap 1; again, such design prolongs the service life of the wire stock fixing device; differently, when use the traditional hook-and-loop fastener, the user usually directly tear by hand, which tear off those edge fiber of the hook-and-loop fastener easily resulting a bad adhesion after repeated use. However, the hard shell 3 serves as a physical protection layer, it not only becomes easy to use, but also protects edges of the wire stock fixing device; and a tearing force on hard shell 3 avoids direct damage on a core hook and loop surface.

Further, the hard shell 3 is designed as arc-shaped structure 31 for corner edges, which avoids scratching the user because of a sharp edge; it again ensures use safety. During production and processing, the hard shell 3 is cut into arc-shaped structure 31 by means of trimming and cutting processes. Correspondingly, a top end of each of the hook elements on the hook surface 12 is designed as a rounded corner to avoid hurting the user.

Preferably, the hook 2 is provided with a spring switch 21; the user open or lock the hook 2 by the spring switch 21; the spring switch 21 belongs to the prior art and will not be redundantly described here.

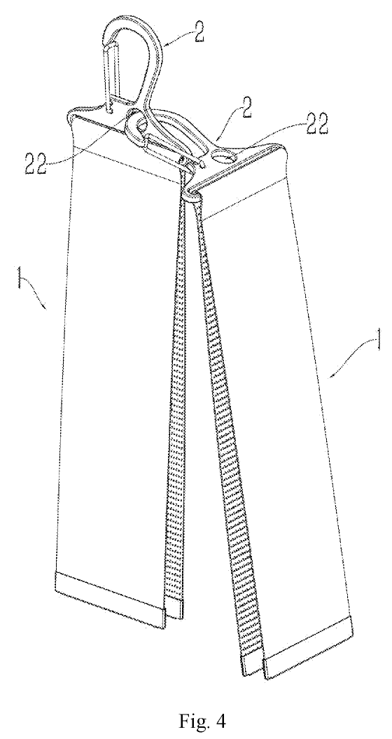

Further, the hook 2 is provided with an additional hole 22; the user can hook one or more wire stock fixing devices together via the additional hole 22; as shown in FIG. 4, two wire stock fixing devices are connected via the additional hole 22. It should be noted that the present invention does not limit a number of wire stock fixing devices hooked together in use; the user can have one or more wire stock fixing devices hooked together via the additional hole 22 according to actual needs, and the user can hang multiple wire stock fixing devices at one same position as well; it could be seen that the wire stock fixing device meets different demands.

In this embodiment, the connecting strap 1 is made of a flame-retardant nylon material; the nylon material itself possesses high strength and toughness, capable of withstanding a relatively high tensile force and a compressive force; since the connecting strap 1 with nylon material characters, the connecting strap 1 becomes more endurable; even under a long-term use condition, the connecting strap 1 can maintain a good performance without breakage or deformation, thereby ensuring a stability and reliability of use; it reduces a maintenance and replacement cost in actual use.

It should be understood that, the present invention just take a usage scenario of the wire stock fixing device in field of electric wires as an example, but in practical applications, the wire stock fixing device can be used to fix and bind various objects, such as tubes, shovels, spades and so on, or used to bind vines, branches, drip irrigation pipes in agriculture field, and the like; as long as the same structure as the present invention is adopted, regardless of the usage function, it should be within the scope of the present invention.

It could be understood that under the guidance of the above embodiments, those skilled in the art can combine various implementation methods in the above embodiments to obtain technical solutions of multiple implementation methods.

The above description is only a preferred embodiment of the present

invention and is not to limit the present invention. Any modifications, equivalent substitutions and improvements made within the spirit and principles of the present invention should be included in the scope of protection of the present invention.

1. A wire stock fixing device, comprising a connecting strap and a hook; the hook connects to the connecting strap; a side of the connecting strap is designed as a loop surface; another side of the connecting strap is designed as a hook surface; the hook surface and the loop surface cooperate with each other forming a detachable connection.

2. The wire stock fixing device according to claim 1, wherein the hook connects to a middle position of the connecting strap.

3. The wire stock fixing device according to claim 1, wherein the connecting strap is integrally formed; the middle position of the connecting strap is set as a bending part; the connecting strap is folded up to make the bending part in curve; a stitching line is sewed at two ends of the bending part; the bending part forms a connecting hole; the hook is connected with the connecting strap via the connecting hole.

4. The wire stock fixing device according to claim 1, wherein the hook surface on the connecting strap is provided with a plurality of rows and columns of hook elements; each of the plurality of rows and columns of hook elements are arranged alternately in left and right directions.

5. The wire stock fixing device according to claim 1, wherein each of two ends of the connecting strap is provided with a hard shell.

6. The wire stock fixing device according to claim 5, wherein the hard shell is designed as an arc-shaped structure for all corner edges.

7. The wire stock fixing device according to claim 1, wherein a top end of each of the hook elements on the hook surface is designed as a rounded corner.

8. The wire stock fixing device according to claim 1, wherein the hook is provided with a spring switch.

9. The wire stock fixing device according to claim 1, wherein the hook is provided with an additional hole.

10. The wire stock fixing device according to claim 1, wherein the connecting
strap is made of a flame-retardant nylon material.
